(19) United States
(12) Patent Application Publication
(10) Pub. No.: US 2010/0283224 A1
(43) Pub. Date: Nov. 11, 2010

(54) Guide System for a Boat Trailer

(76) Inventor: Dan Allen, Rolfe, IA (US)

Correspondence Address: TIM COOK, P.O. BOX 10107, LIBERTY, TX, 77575, US

(21) Appl. No.: 12/436,377

(22) Filed: May 6, 2009

(51) Int. Cl. B60P 3/10

(52) U.S. Cl. 280/414.1; 414/462

(57) ABSTRACT

A boat trailer guide system for effectively launching and retrieving a boat. The system comprises a guide frame that can be removably attached to a boat trailer. The guide frame comprises two guide rails that are horizontally and vertically symmetrical. Each guide rail has a first end and a second end. The first ends of the guide rails converge and are attached to the trailer frame through the previously mentioned upright structure on the “bow” end of the trailer. The second ends diverge in the direction of the “stern” end of the trailer. The lengths of the two guide rails are such that the second ends extend toward the vicinity of the trailer wheels, or even extend past the trailer wheels to the stern end of the trailer frame. The guide rails are preferably curved symmetrically both vertically and horizontally such that they match the general contour of the hull of the trailed boat. The guide frame is preferably removably attached to the trailer frame so that it can be modified or even exchanged if a different type of boat is trailed

### FIELD OF THE INVENTION

This invention is directed toward apparatus and methods for launching and retrieval of a boat from a boat trailer. More particularly, the invention allows the boat to be launched and retrieved by a single individual under high current and/or windy conditions.

### BACKGROUND OF THE INVENTION

Boat trailers have been used for many years to tow boats from one location to another. Typically a boat is towed from a dry storage area to a body of water, launched from the trailer into the water, and subsequently retrieved onto the trailer. It is advantageous for one person to launch and retrieve the boat under all conditions including high winds and strong currents. It is also highly desirable to minimize the possibility of damage to the boat, especially during retrieval onto the boat trailed

A typical boat trailer comprises a frame and at least one axle with typically two wheels. The frame includes an extension member, or “tongue”, which contains a latching mechanism to connect the trailer to a towing vehicle. As an example, a male latch member, or “ball”, is mounted at the rear of a towing vehicle, and a female latch mechanism is mounted on the tongue of the trailer to removably grasp the ball and thereby connect the trailer to the towing vehicle.

Prior art boat trailers often provide additional “guide” structure to assist in launching the boat and especially in retrieving the boat onto the trailer. U.S. Pat. No. 4,103,925 discloses parallel, horizontal guide rails that assist in positioning a boat on a boat trailer. U.S. Pat. No. 5,360,226 discloses vertical spring loaded vertical guides that likewise assist in positioning a boat on a boat trailer. Numerous prior art boat trailers employ a small, horizontal “V” structure to guide the stem of a boat's bow, in the final stage of retrieval, so that it abuts a vertical trailer structure such as a winch bracket. An example of this structure is disclosed in U.S. Pat. No. 3,989,266. These prior art systems can introduce various operational problems, especially when one person attempts to launch or retrieve a boat under adverse conditions such as high winds and swift currents.

### SUMMARY OF THE INVENTION

The invention is a boat trailer guide system for effectively launching and retrieving a boat. The system comprises a guide frame that can be removably attached to a boat trailer. The guide frame comprises two guide rails that are horizontally and vertically symmetrical. Each guide rail has a first end and a second end. The first ends of the guide rails converge and are attached to the trailer frame through the previously mentioned upright structure on the “bow” end of the trailer. The upright structure can be an element of the guide frame, or alternately be an element of the boat trailer such as an upright member onto which a winch is disposed. The second ends diverge in the direction of the “stern” end of the trailer to a width preferably slightly greater than the width of the boat to be trailered. An upper end of an upright stem bracket is affixed to the each guide rail in the vicinity of the guide rail's second end. A lower end of the upright stem bracket is affixed to the trailer frame. This secures each guide rail to the frame of the trailer. The lengths of the two guide rails are such that the second ends extend toward the vicinity of the trailer wheels, or even extend past the trailer wheels to the stem end of the trailer frame.

The guide rails are preferably curved symmetrically both vertically and horizontally such that they match the general contour of the hull of the trailered boat. The guide frame is preferably removably attached to the trailer frame so that it can be modified or even exchanged if a different type of boat is trailed.

The guide frame can be removably attached to a boat trailer with a “fixed” tongue as disclosed in previously referenced U.S. Pat. Nos. 4,103,925 and 5,360,226, or alternately removably attached to a boat trailer with an extendable tongue of the type disclosed in U.S. Pat. No. 6,685,209 B1.

### BRIEF DESCRIPTION OF THE DRAWINGS

So that the manner in which the above recited features, advantages and objects of the present invention are attained can be understood in detail, a more particular description of the invention, briefly summarized above, may be had by reference to the embodiments thereof which are illustrated in the appended drawings. It is to be noted, however, that the appended drawings illustrate only typical embodiments of the invention and are therefore not to be considered limiting of its scope, for the invention may admit to other equally effective embodiments.

FIG. 1 is a perspective view of a boat trailer guide frame;

FIG. 2 is a rear view of a preferred embodiment of a bow bracket in partial section;

FIG. 3 is a cross sectional view of a guide rail in a preferred embodiment as seen along section lines 3-3 in FIG. 1;

FIG. 4 is a top view of the guide frame mounted on a boat trailer mounted on a boat trailer; and

FIG. 5 is a side view of the guide frame mounted on a boat trailer mounted on a boat trailer, with a boat positioned thereon.

### DETAILED DESCRIPTION OF PREFERRED EMBODIMENTS

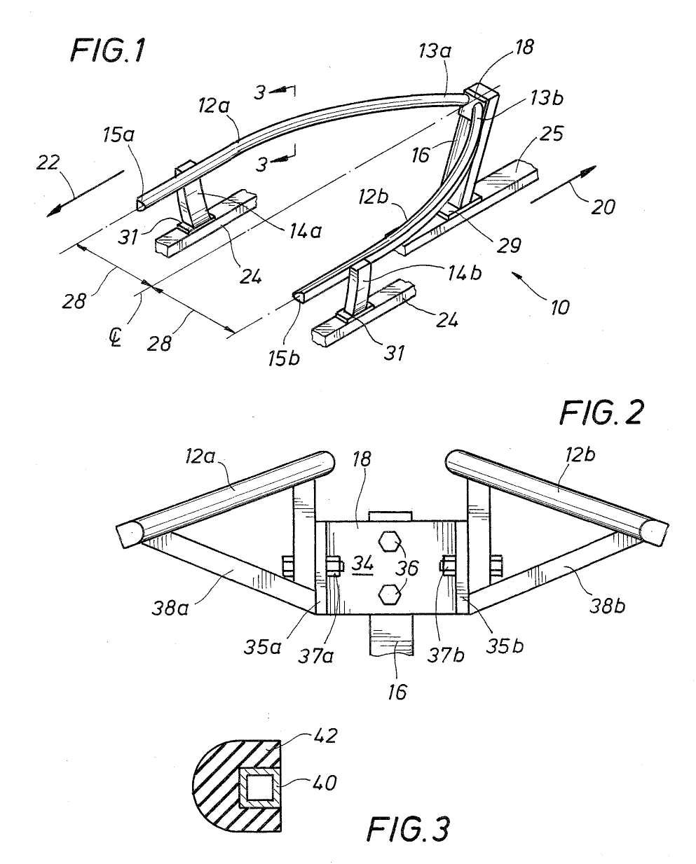

FIG. 1 illustrates in perspective the boat trailer guide frame and is identified as a whole by the numeral 10. The guide frame 10 comprises first and second guide rails 12a and 12b, respectively, that are disposed horizontally symmetrical about a centerline 26. Guide rail 12a has a first end 13a and a second end 15a and guide rail 12b has a first end 13b and a second end 15b. The first ends of the guide rails 12a and 12b converge toward the “bow” end of the trailer, which is indicated by the arrow 20. These first ends of the guide rails 12a and 12b are preferably attached to a bow bracket 18, which is secured to an upper end of a bow upright structure 16. The lower end of the bow upright structure 16 is attached to the “tongue” 25 of the boat trailer frame 24 by an attachment means shown generally at 29. Attachment means 29 may include, but is not limited to, bolts, screws, “U” bolt clamps and the like. This arrangement securely and removably fastens the first ends of the guide rails through the upright structure 16 to the tongue 25 of the boat trailer. The upright structure can be an element of the guide frame 10, or can be an existing element of the boat trailer such as an upright member onto which a winch (not shown) is disposed.

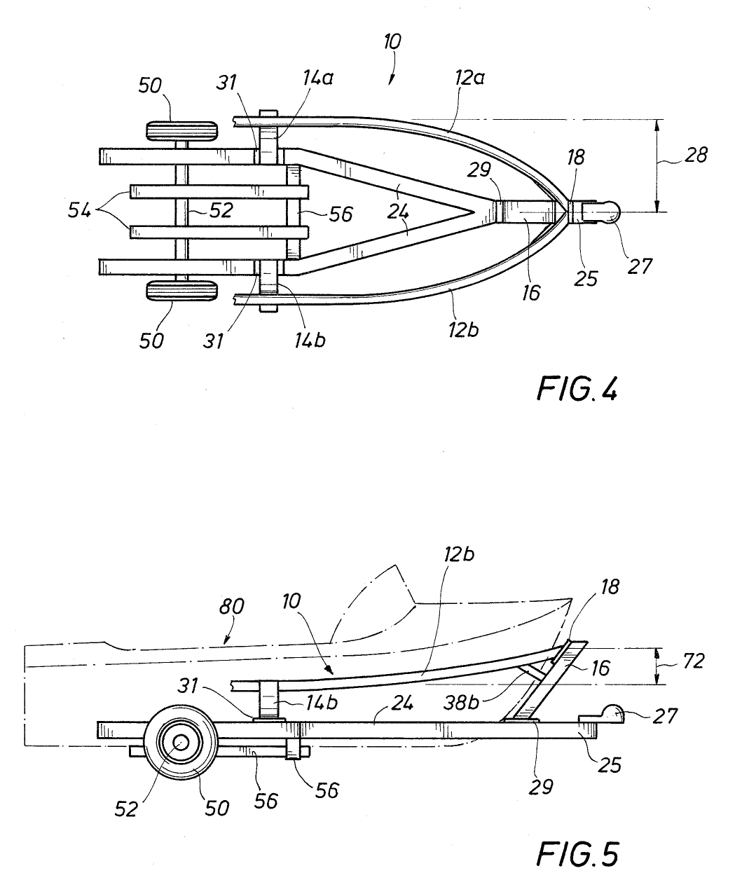

Again referring to FIG. 1, the second ends 15a and 15b of the guide rails 12a and 12b diverge in the direction of the “stem” end of the trailer, as indicated by the arrow 22. An upper end of a first upright stern bracket 14a is attached to guide rail 12a, and an upper end of a second upright stern bracket 14b is attached to guide rail 12b. Lower ends of upright stern brackets 14a and 14b are attached to the trailer frame 24 by attachment means shown generally at 31. This removably secures each guide rail 12a and 12b to the frame 24 of the trailer. Again, attachment means 31 may include, but is not limited to, bolts, screws, “U” bolt clamps and the like. More than two upright stem brackets can be used if needed to support the guide rails. The lengths of the guide rails 12a and 12b are such that their second ends 15a and 15b extend toward the vicinity of the trailer wheels, or even extend past the trailer wheels to the stern end of the trailer frame as can be better seen in FIGS. 4 and 5.

Still referring to FIG. 1, the guide rails 12a and 12b are preferably curved symmetrically both vertically and horizontally such that they match the general contour of the hull of the trailered boat. Horizontal symmetry is in reference to the centerline 26, with a maximum width illustrated by the dimension 28. Vertical curvature can best be seen in FIG. 5. The guide rails diverge at their second ends 15a and 15b to a maximum width that is twice the dimension 28. This width is preferably slightly greater than the width of the boat to be trailed.

FIG. 2 illustrates a preferred embodiment of the bow bracket 18. The bow bracket comprises a plate 34 that is attached to the bow upright structure 16 using fasteners 36. Brackets 35a and 35b extend from the plate 34 at essentially right angles. Braces 38a and 38b are secured to the guide rails 12a and 12b, respectively. The braces 38a and 38b are also secured to the brackets 35a and 35b by fasteners 37a and 37b, respectively. Fasteners are illustrated as bolts and nuts, but can also be screws, “U” bolt clamps and the like. Whether the upright structure 16 is an integral part of the guide frame 10 or an existing element of the boat trailer, the bow bracket 18 can be easily removed from the bow upright structure 16. It should be noted that the bow bracket 18 is but one type of bracket that can be used to secure the guide rails 12a and 12b to the bow upright structure 16, and other types of brackets can be used with equally effective results.

FIG. 3 is a cross sectional view of the guide rails 12a, 12b in a preferred embodiment. Each guide rail comprises a strength element 40, which can be circular or rectangular and can be solid or hollow. The strength member 40 is illustrated as a hollow rectangle member. The strength member is preferably fabricated from formable metal such as aluminum or steel, although other materials can be used such as composites. The strength member 40 is preferably encased in a pliable material 42 such as rubber or a polymer. The pliable material is preferably contoured on the surface which contacts the hull of a boat thereby reducing abrasion damage to the boat hull.

FIG. 4 is a top view of the guide frame 10 mounted on a boat trailer. The bow end of the trailer comprises a female portion 27 of a hitch mounted on the tongue 25, which is an extension of the trailer frame 24. Elements 52 and 56 are cross braces of the boat trailer frame. Guide rails 12a and 12b extend symmetrically from the upright structure 16 toward the stem end of the guide frame 10. The guide rails can extend sternward to the vicinity of loading pads 54, or to the vicinity of the trailer wheels 50 and axle 52, or even extend to the stem end of the trailer frame 24. The bow upright structure 16 is shown canted forward to more closely match the geometry of a typical boat stem. The divergence and the symmetrical horizontal curvature of the guide rails are again illustrated by the dimension 28.

FIG. 5 is a side view of the guide frame 10 mounted on a boat trailer. A boat 80 is illustrated in “phantom” with broken lines. The female portion 27 of the hitch is again shown mounted on the tongue 25, with the bow upright structure 16 canted forward to more closely match the geometry of the boat's stem. Guide rail 12a overlays 12b in the side view and is, therefore, not shown. Again, it is noted that the guide rails 12a and 12b can extend stemward to the vicinity of loading pads 54, or to the vicinity of the trailer wheels 50 and axle 52, or even extend to the stem end of the trailer frame 24. The dimension 72 illustrates the symmetrical vertical curvatures of the guide rails 12a and 12b.

A boat is retrieved onto a trailer comprising a guide bracket by first steering the boat so that the bow of the boat moves between the second ends of the first and said second guide rails 12a and 12b. Steering of the boat is continued forward until the stem of the boat bow simultaneously contacts the converged first ends of the first and second guide rails 12a and 12b.

A boat is launched from a trailer comprising a guide bracket by essentially reversing the above procedure.

While the foregoing disclosure is directed to the preferred embodiments of the present invention, other and further embodiments of the invention may be devised without departing from the basic scope thereof, and the scope thereof is determined by the claims which follow.

I claim:

1. A guide frame for mounting on a boat trailer, said guide frame comprising:
(a) a first guide rail with a first and a second end; and
(b) a second guide rail with a first and a second end; wherein
(c) said first ends of said first and said second guide rails converge toward a bow end of said guide frame; and
(d) said second ends of said first and said second guide rails diverge toward a stern end of said guide frame

2. The guide frame of claim 1 further comprising:
(a) a bow upright structure with an upper end and a lower end;
(b) a first upright stem bracket with an upper and a lower end; and
(c) a second upright stem bracket with an upper and a lower end; wherein
(d) said upper end of said first stem bracket is affixed to said first guide rail in the vicinity of said second end of said first guide rail; and
(e) said upper end of said second stem bracket is affixed to said second guide rail in the vicinity of said second end of said second guide rail.

3. The guide frame of claim 2 wherein said first and second guide rails diverge horizontally with symmetrical curvature.

4. The guide frame of claim 2 wherein said first and second guide rails diverge with vertically symmetrical curvature.

5. The guide frame of claim 2 wherein said lower end of said bow upright structure and said first stem bracket and said second stern bracket are removably attached to said boat trailer.

6. The guide frame of claim 1 wherein said first and second guide rails comprise a strength member covered with a pliable material.

7. The guide frame of claim 1 wherein said first and said second guide rails are horizontally and vertically symmetrically curved to match a contour of an outer surface of a hull of a boat.

8. A guide frame for mounting on a boat trailer, said guide frame comprising:
(a) a first guide rail with a first and a second end;
(b) a second guide rail with a first and a second end;
(c) a bow upright structure;
(d) a first upright stem bracket with an upper and a lower end; and
(e) a second upright stem bracket with an upper and a lower end; wherein
(f) said first ends of said first and said second guide rails are attached to an upper end of said bow upright structure;
(g) said second ends of said first and said second guide rails diverge horizontally and vertically symmetrically toward a stern end of said guide frame;
(h) said upper end of said first stem bracket is affixed to said first guide rail in the vicinity of said second end of said first guide rail; and
(i) said upper end of said second stem bracket is affixed to said second guide rail in the vicinity of said second end of said second guide rail.

9. The guide frame of claim 8 wherein said guide frame is removably attached to said boat trailer.

10. The guide frame of claim 8 wherein said first and second guide rails comprise a strength member covered with a pliable material.

11. The guide frame of claim 8 wherein said first and said second guide rails are horizontally and vertically symmetrically curved to match a contour of an a outer surface of a hull of a boat.

12. A method for retrieving a boat onto a boat trailer, the method comprising:
(a) mounting a guide frame on said boat trailer, said guide frame comprising
a first guide rail with a first and a second end,
a second guide rail with a first and a second end,
a bow upright structure,
a first upright stem bracket with an upper and a lower end, and
a second upright stem bracket with an upper and a lower end, wherein
said first ends of said first and said second guide rails are attached to an upper end of said bow upright structure,
said second ends of said first and said second guide rails diverge horizontally and vertically symmetrically toward a stem end of said guide frame,
said upper end of said first stem bracket is affixed to said first guide rail in the vicinity of said second end of said first guide rail; and
said upper end of said second stern bracket is affixed to said second guide rail in the vicinity of said second end of said second guide rail;
(b) steering said boat so that the bow of said boat moves between said second ends of said first and said second guide; and
(c) continue to steer said boat until the stem of the boat bow simultaneously contacts said converged first ends of said first and said second guide rails.
